(19) United States
(12) Patent Application Publication
(10) Pub. No.: US 2010/0061695 A1
(43) Pub. Date: Mar. 11, 2010

(54) METHOD AND APPARATUS FOR PRODUCING RE-CUSTOMIZABLE MULTI-MEDIA

(76) Inventors: Christopher Furmanski, Tarzana, CA (US); Jason Fox, Thousand Oaks, CA (US)

Correspondence Address: FLIESLER MEYER LLP, 650 CALIFORNIA STREET, 14TH FLOOR, SAN FRANCISCO, CA, 94108, US

(21) Appl. No.: 12/618,543

(22) Filed: Nov. 13, 2009

Related U.S. Application Data
(62) Division of application No. 11/356,464, filed on Feb. 15, 2006, now abandoned.
(60) Provisional application No. 60/652,989, filed on Feb. 15, 2005.

(51) Int. Cl. H04N 5/93

(52) U.S. Cl. 386/52

(57) ABSTRACT

The present invention is a method and system that facilitates the production of personalized movies. The invention enables the repeated and high-volume generation of unique, customized multi-media (e.g., movies) from a collection of stock media. A production method for creating personalized movies comprises the steps of receiving user-provided media, receiving parameters which define how the user wants the movies to be personalized, and integrating the user-provided media into predefined spatial and temporal portions of stock media utilizing a compositing algorithm to form a composited movie. In addition, the method may also include the step of comparing and rescheduling production tasks along relevant dimensions utilizing an optimization algorithm in accordance with received parameters.

### CROSS-RELATED APPLICATIONS

This application claims the benefit of Provisional Patent Application No. 60/652,989 titled “Method and apparatus for producing re-customizable multi-media,” filed 2005 Feb. 15, which is hereby incorporated by reference herein.

### DESCRIPTION OF THE INVENTION

1. Field of the Invention

The present invention relates to multi-media creation, and more specifically to the high-volume production of personalized multi-media that utilizes images, sounds, and text provided by the end user.

2. Background of the Invention

Digital multi-media presentations are commonly used for story-telling and education. Commercially available, mass-marked multi-media presentations, such as animated home videos, typically convey the actions, images, and sounds of people other than those of the viewer.

Inventors have created several types of commercial and home video editing software so that people may cut, rearrange, and add transitions, titles, and special effects in order to produce their own videos. For example, U.S. Pat. No. 6,154,600 to Newman et al., (2000) discloses a non-linear media editor for editing, recombining, and authoring video footage. However, such editors require significant human interaction and hence lack the automation and multi-task optimization to do large-scale high-speed video production. These non-linear media editors do not include or do not have access to professional media, and are potentially expensive and complicated for end user.

Other attempts to create personalized videos, such as those described in U.S. Pat. No. 6,061,532 to Bell (2000), involve creating personalized video movies with images and audio clips, but further require subjects to attain a series of predefined poses corresponding to specific events in the video movie. As such, these techniques are inflexible and generally unsatisfactory.

### SUMMARY OF THE INVENTION

In view of the foregoing, the invention provides a production method and apparatus for creating personalized movies.

According to one embodiment, the present invention provides a production method for creating personalized movies. The method includes the steps of receiving user-provided media, receiving parameters which define how the user of the system wants the movie to be personalized, and integrating the user-provided media into predefined spatial and temporal portions of stock media utilizing a compositing algorithm to form a composited movie.

According to various aspects of the invention, predetermined aspects of user-provided media may be altered with respect to the received parameters prior to integrating. In addition, the method may further include a preparation step that prepares the user-provided media and stock media for integration. The preparation step may include a character skin-tone shading algorithm that adjusts the stock media to account for variations in the user-provided media due to lighting and natural tonal variation. The preparation step may also include a spatial warping over time algorithm to attain alternative perspectives of user-provided media. In addition, the stock media may be analyzed to generate parameters for the manipulation of the user-provided media. In particular, the analysis may include tracking corners of a place-holder photo in time to produce control parameters for 2D and 3D compositing of the user-provided media in the stock media.

According to another embodiment, the invention provides a production method for creating personalized movies. The method includes the steps of receiving user-provided media, receiving parameters which define how the user of the system wants the movies to be personalized, and optimizing production tasks along relevant dimensions utilizing an optimization algorithm in accordance with the received parameters.

According to various aspects of the invention, the optimization algorithm utilizes load balancing techniques to maximize order throughput. The load balancing technique includes the steps of analyzing scheduled activity, including disk activity, for potential performance penalties, minimizing disk activity that imposes performance penalties identified in the analyzing step, and maximizing in-memory computation. Typically, the production tasks are performed by two or more CPUs and the optimization algorithm divides the production among available CPUs along orthogonal dimensions, including orders, stories, scenes, frames, user, and user media. The optimization algorithm may also include the step of performing dynamic statistical analysis on historical orders and current load used for strategic allocation of resources.

It is to be understood that the descriptions of this invention herein are exemplary and explanatory only and are not restrictive of the invention as claimed.

### BRIEF DESCRIPTION OF THE DRAWINGS

FIG. 1 depicts a system for creating personalized movies according to one embodiment of the invention.

FIG. 2 depicts the preferred data types, hardware, and software for both the production and business computers according to the embodiment shown in FIG. 1.

FIG. 3 depicts the method steps for creating a personalized movie according to one embodiment of the invention.

FIG. 4 depicts one example of resource allocation for the production of personalized movies according to embodiment of the invention.

FIG. 5 depicts another example of resource allocation for the production of personalized movies according to one embodiment of the invention.

FIG. 6 depicts the overall structure of metadata files and content files according to one embodiment of the invention.

FIG. 7 depicts one example of a possible configuration of stock and custom media that makes up a complete video according to one embodiment of the invention.

FIG. 8 depicts the video content template structure for the example video configuration shown in FIG. 7 according to one embodiment of the invention.

FIG. 9 depicts representative examples of file content according to one embodiment of the invention.

FIG. 10 depicts an example of improved performance achieved utilizing the production task optimization according to one embodiment of the invention.

FIG. 11 depicts one example of the general arrangement of the layers in stock media according to embodiment of the invention.

FIG. 12 depicts examples of layers according to one embodiment of the invention.

FIG. 13 depicts an exploded and assembled view of character layers according to one embodiment of the invention.

FIG. 14 depicts steps for preparing and compositing a user-provided face photo into stock media according to one embodiment of the invention.

### DESCRIPTION OF THE EMBODIMENTS

Reference will now be made in detail to the present exemplary embodiments of the invention, examples of which are illustrated in the accompanying drawings.

The invention enables end-users to create their own personalized movies by, for example, embedding their own faces on characters contained in stock media. In addition, characters may be personalized with the user's own voice and characters may interact with user-provided media. Users may choose from various modes of personalized media including customization of text, audio, speech, behavior, faces, character's physical characteristics related to gender, age, clothing, hair, voice, and ethnicity, and various other character and object properties such as identity, color, size, name, shape, label, quantity, or location. Furthermore, users can customize the sequencing of pre-created stock media and user-provided media to create their own compositions or storylines.

To allow for a higher quality finished product and increased flexibility when embedding such user-provided media, the invention provides automated techniques for altering stock media to better conform to the user-provided media and automated techniques for compositing user-provided media with stock media. For example, the invention provides automated techniques for character skin-tone shading that can adjust stock media to account for variations in user-provided media due to lighting and natural tonal variation (for example, multi point sampling, edge point sampling, or statistical color matching approaches). In addition, the invention provides spatial warping over time (animated warping) techniques to attain alternative perspectives of user-provided media (e.g., images) to enhance stock character personalization.

The invention also provides for automated analysis of pre-created media (i.e., stock media) to generate necessary parameters for manipulation of custom footage (i.e., user-provided media). For example, corners of a place-holder photo in the stock media are tracked in time to produce control parameters for 2D and 3D compositing of the user-provided media. In addition, the invention provides for compositing numerous types of user-provided media and stock media using numerous alpha channels, where each channel is associated with a specific compositing function or type of user-provided media. Alpha Channels may be associated with any media type, for example: images, video, audio, and text.

In addition to techniques for improving the composition of the personalized movies, the invention also provides methods and systems for optimizing production tasks. For example, the methods and systems of the invention may utilize preprocessing techniques to render animation, scene composition, effects, transitions, and compression to limit post-order processing. Where possible, scenes are completely generated, including compression, and concatenated with scenes requiring customization. Additionally, embodiments of the invention may include optimizing fast compression algorithms that focus on minimizing disk read during loading.

Embodiments of the invention may also utilize load balancing to maximize order throughput, including minimizing disk activity that imposes performance penalties and maximizing in-memory computation. Processing may be divided among available CPUs along orthogonal dimensions: orders, stories, scenes, frames, user, and user media. The invention also includes the feature of utilizing dynamic statistical analysis of historical orders and current load used for strategic allocation of resources (i.e., some orders might be deferred until additional similar requests are made). Potential future ordering patterns are profiled based on user history, profile or demographic for the purpose of targeting marketing, advertising, monitoring usage, and generating lists of most popular media.

Due to the automation of many of the features of the methods and systems of the invention, this approach is significantly quicker and easier than using consumer or professional video-editing and animation software and ultimately provides end-users access to high-end capabilities with lower personal cost and minimal time and effort. In addition, for the manufacturer, the methods and systems of the invention provide for a faster end-to-end solution enabling commercially viable mass-production of movies to support high-volume consumer demand for each product to be unique and specifically tailored to and by each end-user. Further in this regard, the invention is applicable for a variety of media formats including DVD, VCD, CD, and electronic (e.g., various emailed or FTP'ed electronic movie formats (AVI, MOV, WMV etc), as well as print versions (books, magazines)).

### Preferred Embodiment

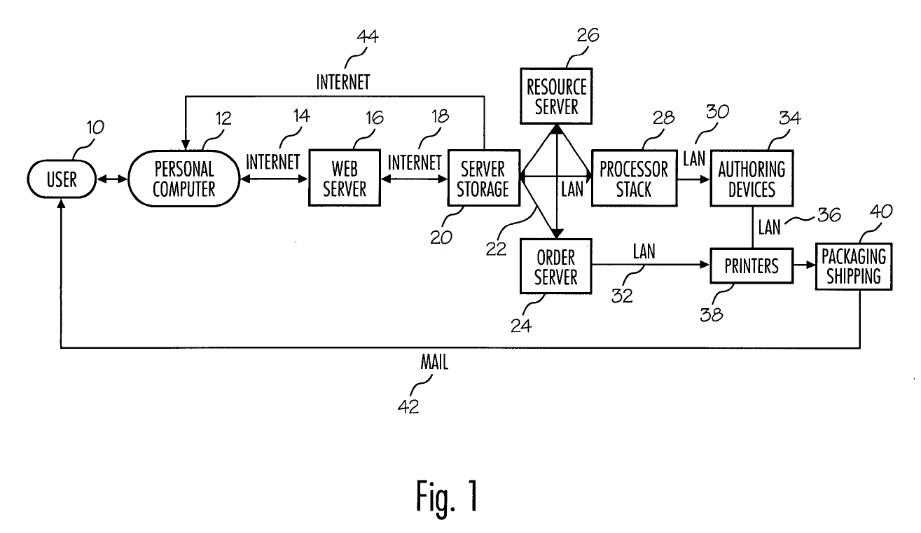

The following is a description of one embodiment of the invention as shown in FIG. 1. Preferably, this embodiment is implemented as a distributed system for use in an e-commerce business where some front-end web services and image processing occur on remote web-servers (16) accessed through a web browser on a personal computer (12) and the bulk of the image processing, production, and shipping occurs at the back-end system (20-44). However, other arrangements and allocations of system functions are also acceptable and will be discussed below under the heading “Other Embodiments.”

Personal Computer (12)—The front end of the system is a personal computer (12) that a User (10) utilizes to interact with a web browser that portrays information on web pages. The web pages are provided by the Web Server (16) interconnected via an Internet connection (14). Using a typical web browser, the User (10) may upload personal multimedia content (i.e., the user-provided media), edit video, and place orders for customized videos (i.e., parameters that define how the user wants the stock media to be customized).

Web Server (16)—Web Server (16) is not collocated with the User's (10) Personal Computer (12) but rather is connected through an Internet connection (14). Web Server (16) provides web-server capability, storage, upload and download capability, read and write abilities, processing, and execution, of applications and data. The Web Server (16) has image processing capabilities, various network protocol capabilities (FTP, HTTP), an email daemon, and has Internet connectivity (18) to the backend system's (20-44) Server/Storage (20) with which it is also not collocated.

Server/Storage (20)—The Server/Storage (20) has local and Internet-transfer capability and is comprised of a file server, databases, and file-storage residing on one or more hard disks used to store stock media, processed user-provided media, user profiles, processor performance logs, intermediate and final forms of multi-media, and order information. The Server/Storage component (20) is connected to Resource Server (26), Order Server (24), and Processor Stack (28) using a Local Area Network (22). The Server/Storage (20) is not collocated with the Personal Computer (12) or the Web Server (16), but connected via the Internet (14, 18 respectively). Server/Storage (20) can send electronic versions of the movies to a user's Personal Computers (12) via the Internet (44), as well as to third-party web-host or storage vendors and also has an email daemon for contacting end-users about various production statuses sent from the Order Server (24).

Order Server (24)—The Order Server (24) is a processing unit dedicated to tracking user's individual order through all phases of the Invention to provide manufacturers and end-users with on-demand or scheduled email and web updates about the production and shipping status. The Order Server (24) is embodied as a software application or a series of applications running on dedicated computer hardware and is connected to the Server/Storage (20), Resource Server (26), and Printers (38) by Local Area Networks (22, 32).

Resource Server (26)—The Resource Server (26) is one or more processing units that manage the workload of Processor Stacks (28). Resource Servers assign complete or partial orders based on current and anticipated orders, balancing priority, time of day (peak hours, mailing deadlines), available computing and publishing resources, and other factors to maximize order throughput and minimize total cost. The Resource Server (26) also performs dynamic statistical analysis of orders to strategically allocate resources through peak and off-peak ordering periods (some orders might be deferred until additional similar requests are made).

Processor Stack (28)—One or more processing units potentially consisting of banks of CPUs sharing memory and storage, running compositing, compression, and encoding software. Each processing unit is optimized to deliver fast image and audio compositing and video compression, minimizing access to storage. Workload is managed by a Resource Server (26) and completed jobs are forwarded to Authoring Devices (34), and Printers (38) as directed by the Resource Server (26).

Authoring Devices (34)—Output devices that create physical media include but are not limited to DVDR, VCDR, VHS, USB outputs. A Resource Server (26) assigns Authoring Devices (34) to coordinate with Processor Stacks (28) to encode completed media on physical media. Menus, legal media, country-codes, and other formatting are automatically incorporated according to media specific specifications and are ultimately encoded the completed media on physical media.

Printers (38)—The Order Server (24) assigns specific tasks to the Printers (38) which include laser, ink-jet, and thermal printers for printing hard copies of customer orders, shipping labels for the boxes, and ink-jet or thermal printed labels for the physical media.

Packaging, Shipping (40)—The Packaging, Shipping (40) is a combination of manual processes for taking completed media from the Printers (38) and Authoring Devices (34), packaging them, affixing mailing labels and postage, and then delivering the media for shipping to the end-user via U.S. or private mail carriers (42).

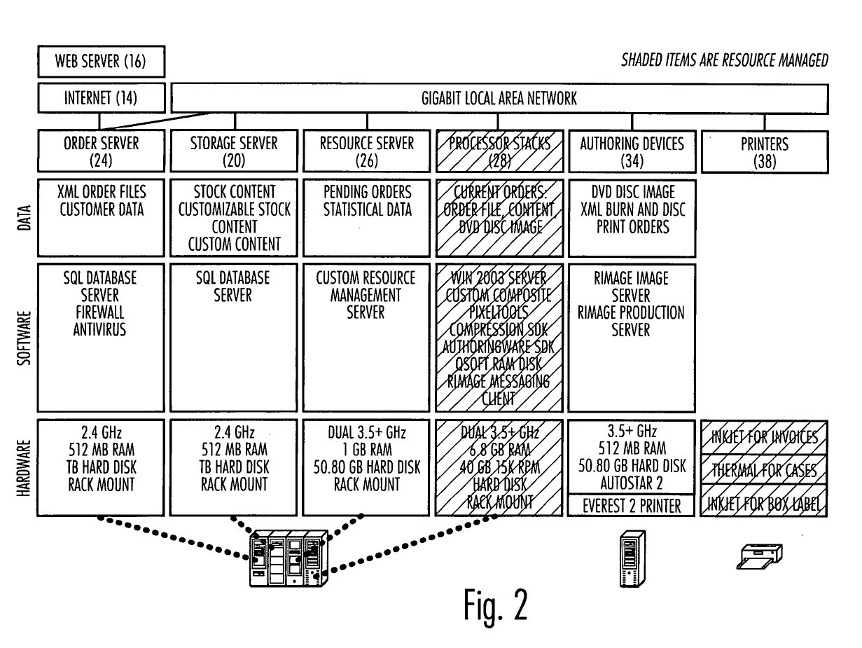

FIG. 2 lists the preferred data types, hardware, and software for both the production and business computers of the embodiment shown in FIG. 1.

### Operation of the Preferred Embodiment

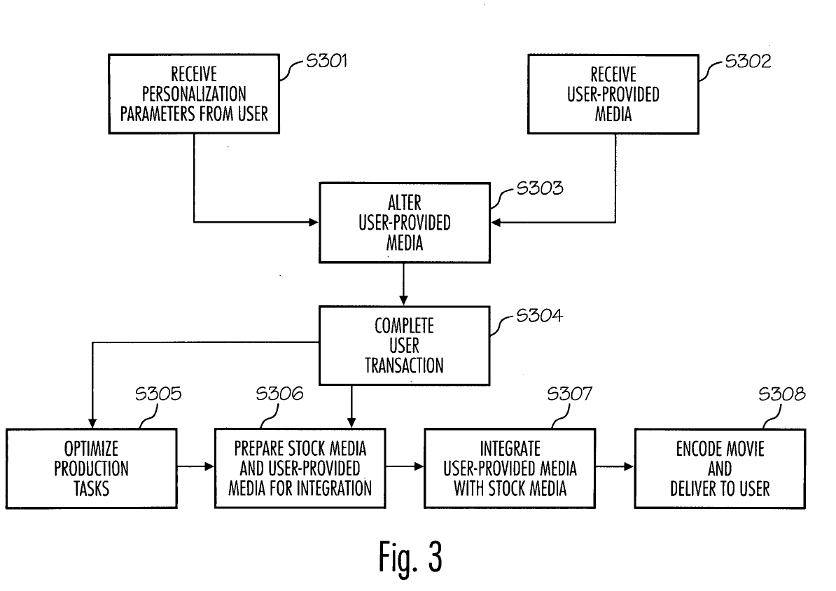

Utilizing the embodiment shown in FIG. 1, a User (10), utilizing Personal Computer (12), interacts with a web browser to purchase and create a series of video shorts and/or movies that are to be personalized with user-provided media (such as faces, voices, and inputted text). The video shorts may be of any type, including animation or live action. The completed video shorts or movies are either transferred to tangible media such as a DVD and shipped to the user or transferred as electronic files to a user-specified location (e.g., personal computer or third party web host). A more detailed list of steps of invention function for one possible embodiment is described below with reference to FIG. 3.

Receive Personalization Parameters from User (S301)—The User Web Experience.

Users (10) visit a website using a web browser on a Personal Computer (12) connected to the Internet (14). Initial connection to the website may require the User login. In such a case the system checks if the specific user account exists, and if so loads preferences. If no user account exists, a new account is created a copy is stored on web server (16). All data is uploaded to the backend system's storage (20) via the Internet (18).

Next, User (10) views available products and pricing information uploaded to web server system (16) from a database in the Server/Storage (20) via the Internet (18). User (10) than selects parameters that will personalize the movie. For example, User (10) may select available products based on theme, segment, storyline, type of characters, or media requirements. Furthermore, User (10) may select final media format. The order is then uploaded to the web server (16) via Internet protocols (14) (e.g., HTTP, FTP).

Receive User-Provided Media (S302)—The User Web Experience

The user is also provided with input requirements for selected media/product.

The User uploads the user-provided media: e.g., digital photographs from a digital camera stored on an external device or their personal computer (12). The user-provided media may also consist of text, speech or sounds, audio and digital music, images of object, videos—essentially any type of media that could be integrated into stock media. The user-provided media is uploaded to the web server (16) using Internet protocols (14) (e.g., HTTP, FTP). Uploading and reception of the user-provided media need not take place after all personalization parameters have been received, but may occur concurrently.

Alter User-Provided Media (S303)—Initial Image processing

Software applications running on the web server (16) verify the uploaded files are of the correct type and virus free, and then proceeds to automatically adjust the file formats, and reduce the size and resolution of the uploaded user-provided media to fit predefined requirements. Reduced versions of photographs may be represented to the user through the web and used for manually registering, aligning and cropping.

Complete User Transaction (S304)

Next, User (10) may select shipping, box & label art, and completes the ecommerce transaction with credit card or electronic payment. This step is optional, as the selection of shipping and payment may be automatically chosen based on previously-stored user data, such as in a user profile. In addition, the selection of box and label art may be received in step S301.

Optimize Production Tasks (S305)

As discussed above, the invention provides techniques for optimizing the production tasks in creating personalized movies. However, use of the optimization techniques is optional and may not be necessary in situations where greater speed and higher-volume production are not needed. In such a case, the preparation techniques in step S306 (discussed below) would begin after completion of the transaction.

The optimization techniques of step S305 may include preprocessing techniques to render animation, scene composition, effects, transitions, and compression to limit post-order processing. Where possible, scenes are completely generated, including compression, and concatenated with scenes requiring customization. Other techniques may include optimizing fast compression algorithms that focus on minimizing disk read during loading, load balancing to maximize order throughput, dividing processing among available CPUs along orthogonal dimensions, and utilizing dynamic statistical analysis of historical orders and current load used for strategic allocation of resources.

With regard to resource allocation, Resource Server (26) is used to allocate processing jobs in order to fill orders. Factors in determining order processing include but are not limited to: current workload compared to the available processors, anticipation of additional orders requiring the same stock media, minimizing repeated transfer of data between memory and disk, order priority (customer chooses rush processing), division of orders by complete order, story, scene, or frame, or desired frame resolution, encoding format, and/or media format of final product. Orders received by the Web Server (16) are logged, processed, and monitored by the Order Server (24), and sent for scheduling and execution by the Resource Server (26). Order server also monitors and provides updates of progress of other components as it relates to the progress of individual orders to be sent to the manufacturers and end-users via web interfaces or email.

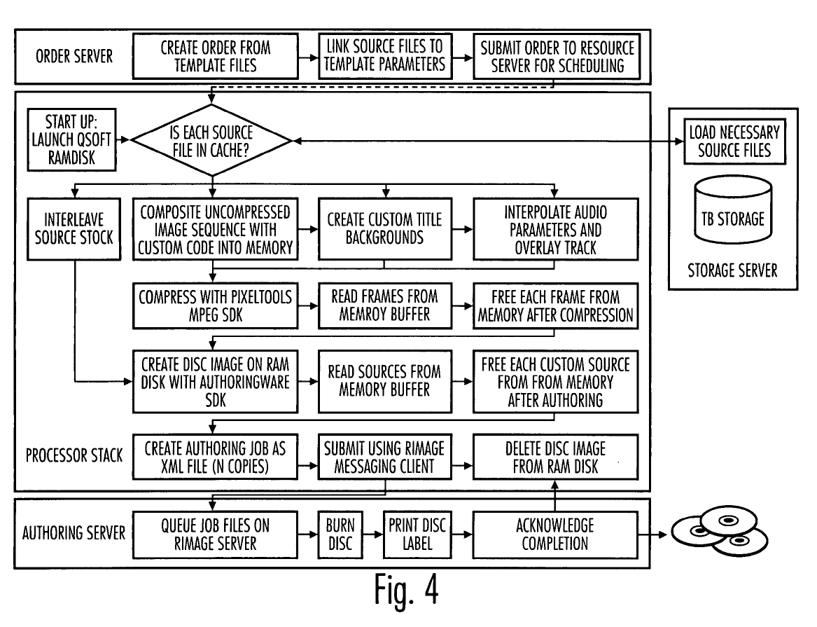

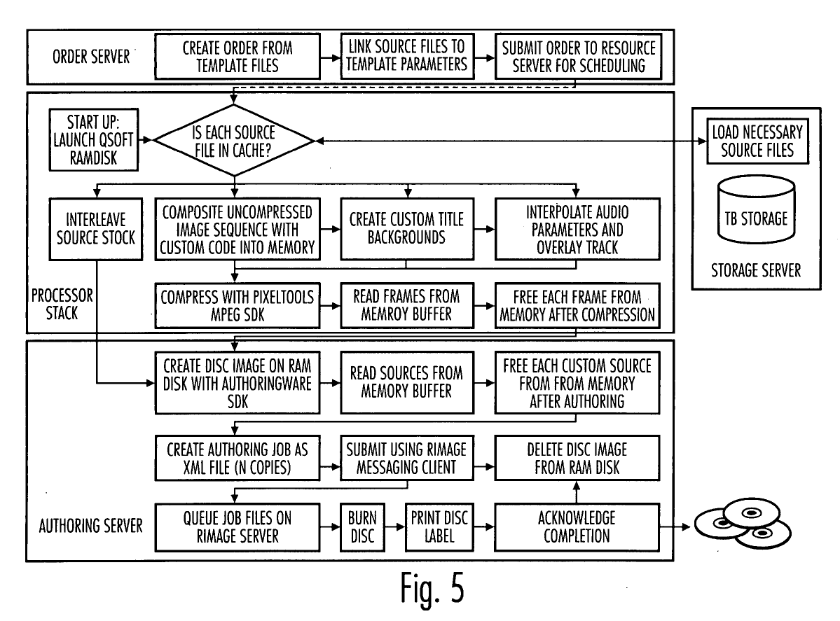

FIGS. 4 and 5 depict two possible timing variations and resource allocations for creating the personalized movie. The major difference between the two is where the creation of the DVD disc image takes place. However, as noted above, the movies may be in any format. In the following descriptions and figures resource management is assumed and not specifically addressed.

In the first variant as shown in FIG. 4, disc images are created on the processor. The basic assumption for this resource allocation is that the fastest possible production will result from maximizing in-memory processing. Preferably, the Processor Stacks enough memory to accommodate in-memory processing of entire videos. For example, to hold content that fills an entire DVD requires 4.7 GB of memory, plus enough to hold the stock media at various stages of processing.

Accessing data on a hard drive tends to be about an order of magnitude slower than accessing data already in main memory. Avoiding disk access wherever possible can greatly improve overall system performance. In the embodiment depicted in FIG. 1, the Processor Stacks will already have all of the stock media in memory since they are responsible for compositing and compressing the custom content. Typically, the system would write the resulting compressed video to disk and then authoring software would later read it. By performing disk authoring on the same machine immediately after compression, the Processor Stacks can avoid the costly additional write and read. Another advantage of this approach is that there are typically many more Processor Stacks than Authoring Servers. This architecture distributes the workload among many machines which could ultimately increase throughput.

FIG. 5 depicts another resource allocation that places the responsibility of creating disc images on the Authoring Server. It is likely that the processors on the Authoring Server will be unoccupied most of the time. This is due to the fact that burning DVDs and printing labels on them will take a long time. For example, according to the manufacturer of Rimage AutoStar 2, a four DVD burner system can complete about 40 discs per hour. At an average time of one and a half minutes per disc, the CPU of the Authoring Server may have available time to generate disc images while it is otherwise idle.

This architecture also provides a clean division between content creation and transfer to media. Other embodiments of the system may deliver media in other formats, such as electronic files via the Internet, FTP, email, and VHS. When the user-provided media is ready, the appropriate Authoring Server can retrieve the data from the Processor Stack and produce the required media. Another advantage of the variant shown in FIG. 5 is a reduced memory requirement on the Processor Stacks, as each machine does not need to store an entire completed disc image.

Another optimization feature of the invention is the pre-processing of stock media. Available video content is typically designed and produced by professional writers and artists. Part of the personalized movie creation process is to determine what and how a user may customize the stock media. The description and details of what may be customized in the stock media is captured in a series of files that together are a video content template. After the user supplies the missing elements (i.e., the user-provided media), such as personal photographs and specified dialog, the system composites the final video based on the template parameters.

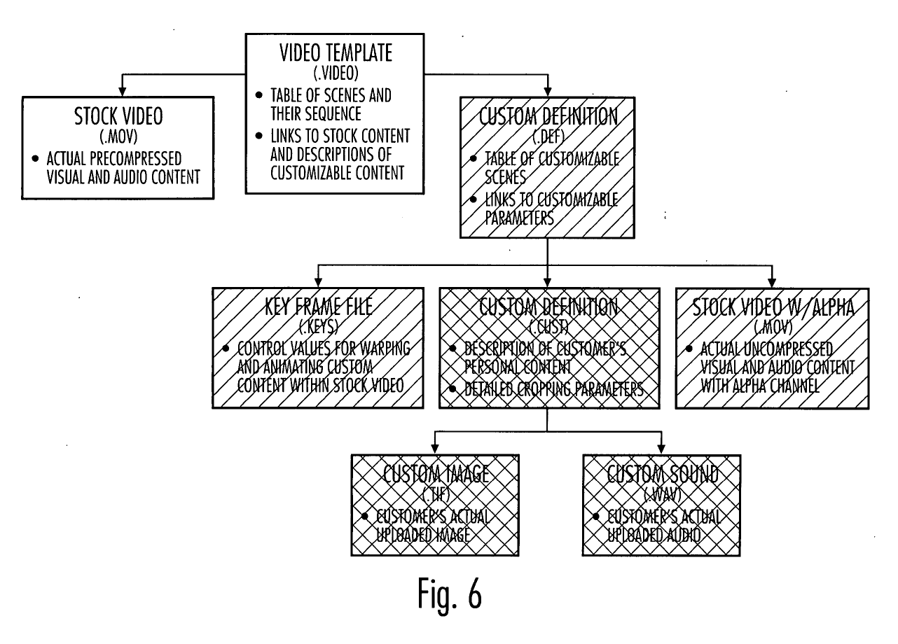

The tables shown in FIGS. 6 to 8 are color coded by their associated content type. Yellow indicates stock media. Blue represents stock media that is designed for customization, usually including one or more alpha channels. Green indicates user-provided media, such as personal photos. Gray shows files needed to combine the various other elements together.

The collection of files comprising a video content template is linked into a hierarchy. FIG. 6 shows one example of an overall structure of metadata files and content files. This design allows reuse of some of the intermediate files and minimizes the number of parameters that need to change when describing a unique instantiation of the video content template.

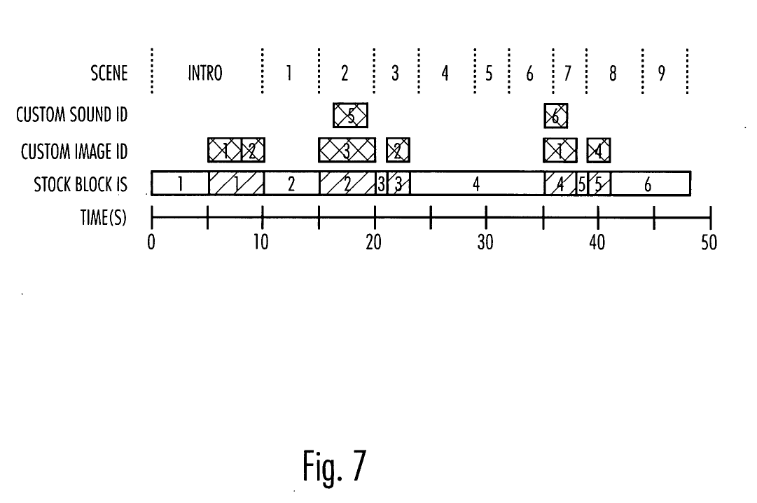

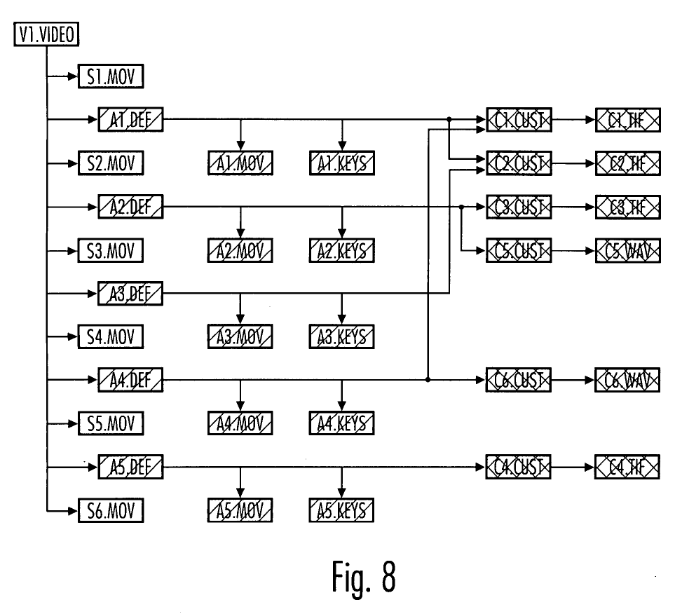

FIG. 7 illustrates an example of a possible configuration of stock and custom content that makes up a complete video. Again, yellow blocks represent stock media that is not customized; blue blocks represent customizable stock media with alpha channels for compositing. User-supplied media is shown as green blocks. Some customized blocks will cross scene boundaries like green 6 and green 1. Likewise, frames in adjacent scenes are aggregated into a single stock block, such as yellow 4 and 6, when there is no compositing necessary in intervening frames. Aggregation reduces the amount of content that needs compression during final production. The video content template structure for the example video configuration is shown in FIG. 8.

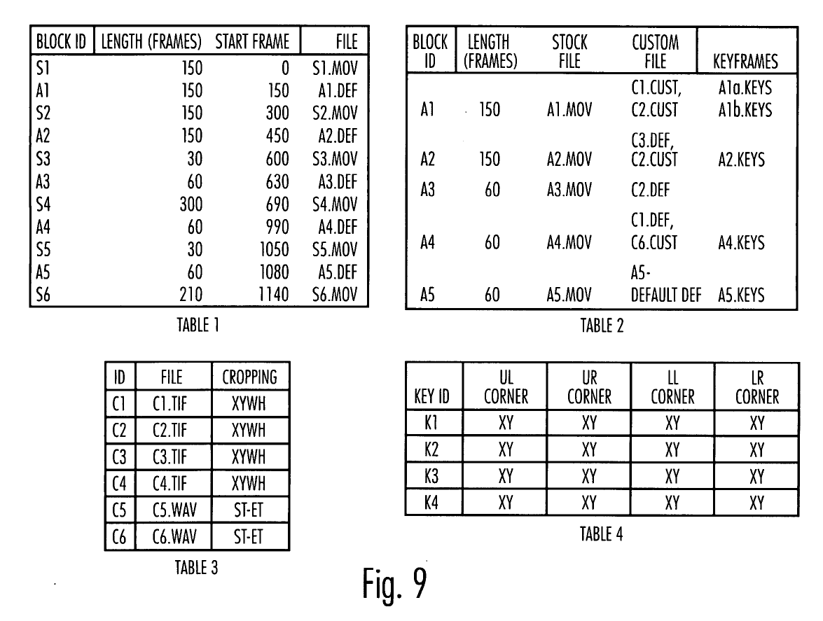

Representative examples of the file contents are shown in the Tables 1 to 4 in FIG. 9. As shown in Table 1, the main video file contains metadata about the stock and customizable blocks. Stock blocks have ID numbers that begin with S and customizable blocks are designated A for alpha. Metadata are provided to aid in compositing, including length and starting frames for the block. A link to files with additional metadata or content is associated with each block.

Customizable stock definitions include the block ID and its block length in frames. Following each entry in Table 2 is the associated file and path to the content sources files and key frame parameters. The content files might be video but will most likely consist of a contiguous series of sequentially numbered images. Both the stock and custom content files will have alpha channels defining where background shows through. Stock files may have an alpha channel per custom file to disambiguate where each composite element should show through.

The system creates a metadata file for each custom content source file supplied by the user (i.e., the user-provided media). As shown in Table 3, this metadata file defines the cropping parameters and potentially other descriptive data for use in automated processing.

Preferably, artists create animations based on key frames for the stock media. As shown in Table 4, the system will automatically extract the necessary key frame data that applies to custom content and create an associated key frame file. The file is later used to morph the user-provided media. Morphing is the process of changing the configuration of pixels in an image. In this context, the term is synonymous with transform. Specifically, perspective and/or affine transformations are performed on the user-provided media. Other linear and nonlinear transformations may also be used. Each column in the key frame file corresponds to a corner of a rectangular image. The corner of the custom image is set to the coordinates specified. The units are in pixels measured from the bottom left corner of the frame.

Another optimization feature of the invention is that the system accomplishes post-order video production in a parallel pipeline. Typically the data processing is the slowest stage of production, and as such, increasing the relative numbers of CPUs in the Processor Stack compared to the number of Authoring Devices will fill in the unused time in the Resource Server, Database Server, and Authoring Devices. Unused time is collectively the periods that a particular resource is not busy. Increasing the number of CPUs while maintaining the number of under-utilized resources will allow those resources to remain busy a greater percentage of the time. In general total order throughput is increased by overlapping production of multiple orders. Multiple Processor Stacks are serviced by relatively few Authoring Devices. Resource optimization reduces production time further by aggregating orders with the same stock media.

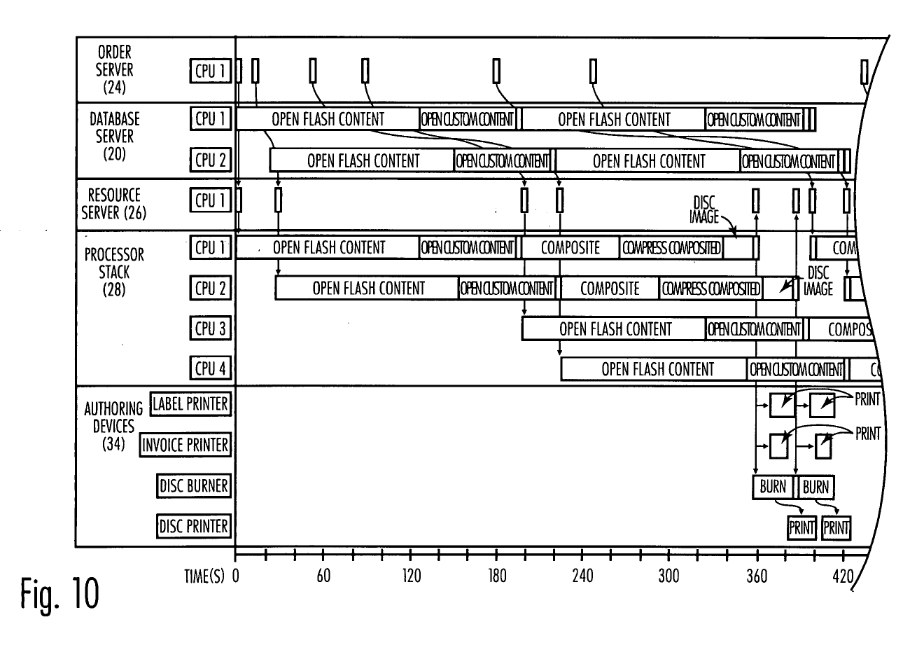

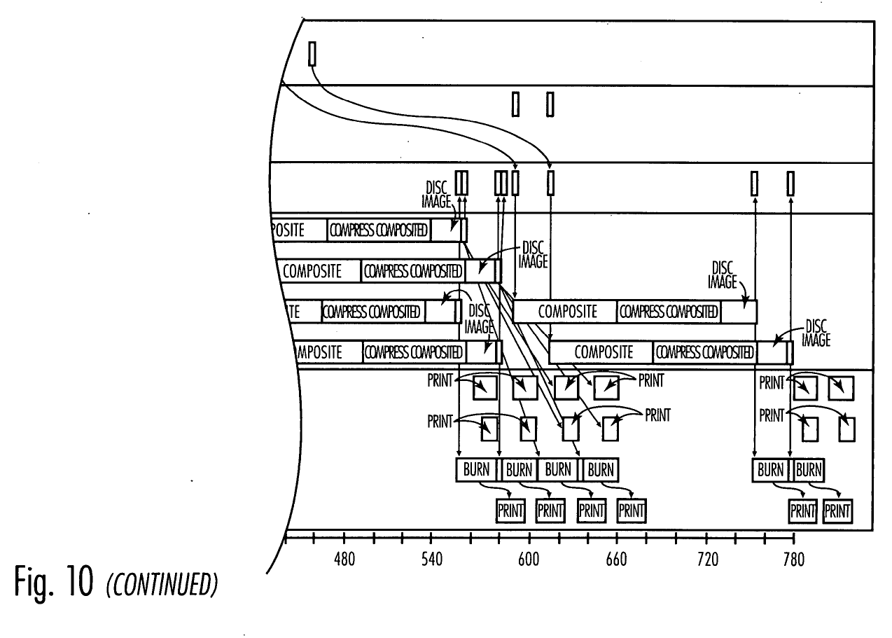

FIG. 10 shows an example of improved performance achieved utilizing the production task optimization of the invention. Initial retrieval of stock media from a hard disk involves a relatively long production time of 405 sec (pink). Subsequent orders benefit by keeping reusable stock media in memory, thus reducing production time to 255 sec (orange) for the same video template.

There are several types of bottleneck conditions that may occur in stages in this pipelined environment. Each is the result of a particular resource reaching its maximum capacity and has its own unique solution described below.

1. The system is initially I/O bound as each processor is bootstrapped with its initial workload

Solution: Fast hard disk drives on the Database Server and fast network connections between Processor Stacks and Database Servers minimize wait time

2. Later, the system is processor bound as resource optimization reduces access to the Database Server

Solution: Adding CPUs will distribute the workload allowing concurrent production of greater numbers of orders

3. After adding CPUs, eventually a threshold is reached where authoring and print devices are at maximum utilization

Solution: Add additional Authoring Devices for productions stages at or near maximum utilization

Prepare Stock Media and User-Provided Media for Integration (S306)

After completion of the transaction (S304) and/or concurrently with the optimization of production tasks (S305), Web Server (16) sends the processed user-provided media and order information (including personalization parameters) to the Server/Storage (20) via Internet protocols (14) (e.g., HTTP, FTP).

First stock media is retrieved from the Server/Storage (20) with templates for insertion of user-provided media from the database. The retrieved media is augmented with sufficient metadata about its preprocessing to allow compositing in the Processor Stack (28) to automatically match the user-provided media to stock media.

Next, software image processing residing on the Processor Stack (28) utilizes face and text-warping algorithms to better prepare user-provided media for integration with the stock media. For example, face and text-warping algorithms involve applying transformations to the matrix of pixels in an image to achieve an artistic effect that allows an observer to experience the content from a perspective other than the original. Perspective and affine transformations are most useful but other linear and nonlinear transformations can also be used. Applying slightly different transformations in successive animation frames can make a static source image appear to rotate or otherwise move consistent with surrounding 2D and 3D animation.

Media creators typically specify key-frame parameters and masks that define how the user-provided media may be incorporated. In addition, the system automatically computes warping parameters depending on factors such as camera movement and mask boundaries. Key frame parameters are interpolated to produce intermediate frame parameters resulting in the full range of image warps for a scene. In this way, user-provided media can be integrated into stock media anywhere in the frame at any time. In addition, by utilizing two or masks to define customizable character features, multiple types of user-supplied media can be incorporated into each scene. For example, multiple characters may be integrated with multiple different user-provided media (e.g., photos of two or more people).

The following describes the preparation techniques used when the user-provided media is a photo of face that is to be integrated into a character found in stock media (e.g., an animated character). The following description is merely one example and is based on the use of a layer-based bone renderer to prepare stock content. In particular, a layer-based bone renderer is most applicable in situations where the portion of the stock media to be personalized is a human, humanlike, or animal character.

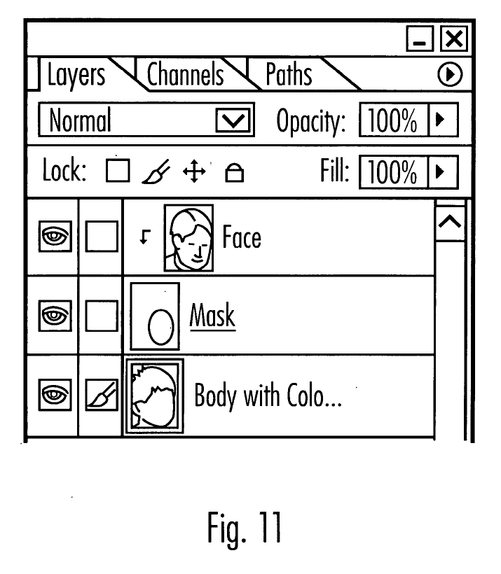

Preferably, the photo of the face should be a separate layer from the rest of the character in the stock media. FIG. 11 shows one example of the general arrangement of the layers. The face layer should preferably receive no selective photo manipulation. Operations that are acceptable include positioning, scaling, rotating, and rectangular cropping of the entire layer. Rectangular cropping is preferred with the edges just touching the head extremities, for example ear to ear and from chin to the top of the head. Preferably, the photo is oriented so the eyes are close to level with the horizon.

In addition, the preparation step may also include operations to the full image such as color correction, balancing, and levels adjustments.

Preferably, the face layer should have a mask as the layer just below it to block unwanted portions of the face photo. The mask will be specific to the character in the stock media and may vary from one character to the next. The face photo is preferably rectangular in standardized portrait orientation and the mask should take that into account. Typically, an artist handcrafts the mask at the same time as the animation. The mask is specific to a character or other customization. The artist should consider the typical proportions of the type of photo he intends the animation to support, for example a portrait oriented photo might require a mask with an aspect ratio less than one.

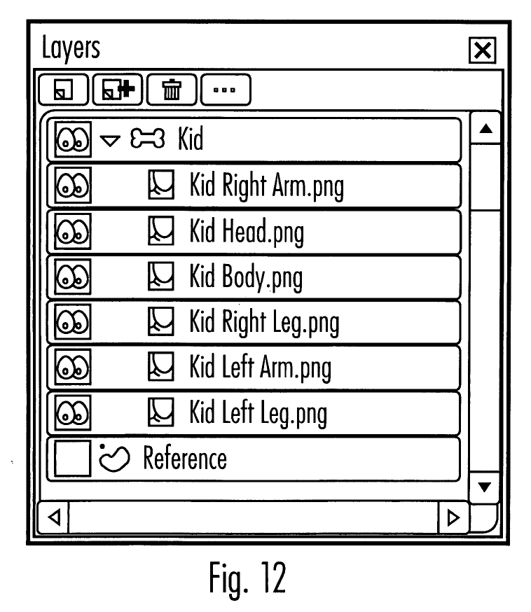

Preferably, the character in the stock media is one or more layers below the face photo and mask. To facilitate 2D animation when animating a body, for example, each body part should be in its own layer. As shown in FIG. 12, typical layers are head, body, left arm, right arm, left leg, and right leg. Other joints are animated using bones that warp the layer geometry. Preferably, each part should be complete, assuming that it will not be occluded. For example the whole leg should be present even if the body includes a full length skirt.

Preferably, each character exhibits three unique views: front, back, and a single side or three quarter view that can be mirrored. However, more views could be used. Typically, only two face photos are needed, one for the front and one for the side. However, one face photo is all that is required. For example, the side view can be a perspective warp of the same photo used for the front to create the illusion that the face is turned slightly to one side. Ideally the heads can be interchanged with the bodies to give the impression that the head is turning from side to side, for example the body facing to the right is used with the front facing head such that the character appears to be looking at the camera.

The face and text warping techniques of the invention are also applicable to full 3-D animation. In order to provide for 3-D animation of the user-provided media, one or more views of a certain feature (e.g., a face) are preferred. In general, the more views of a certain feature that are provided by the user, the smoother the animation can be created. In general, a 3D surface representing a face is approximated by a triangular mesh. The user's source photo is registered and normalized. The normalized face image is texture mapped onto a 3D surface. Consistent with a 2D approach, the skin color may be applied as a background. Then the 3D face mesh is rendered using Open GL or equivalent according to the animation parameters. Then other customizations are applied and finally the foreground stock content is composited on top with transparency where customizations should show through.

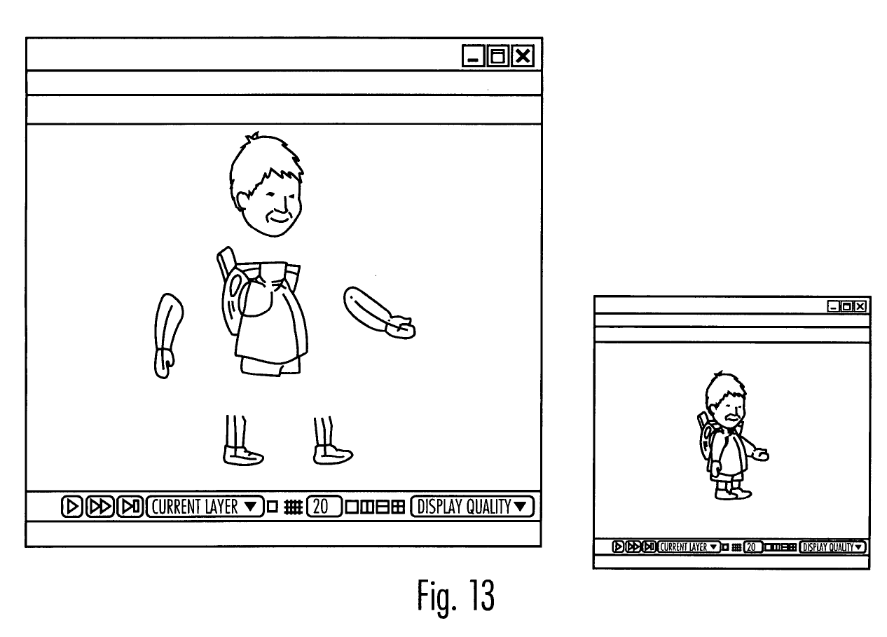

Preferably, characters consist of a parent bone layer and multiple image layers that warp to conform to the animated bones. The image layers are added to the bone group FIG. 12 and spread out in a logical fashion some distance from the character's main body, as shown in FIG. 13. FIG. 13 shows the initial bone set up of the character art as well as the parts reassembled into their natural positions.

The root bone is in the character's waist (highlighted in red). A bone is created for each articulated part of each limb, such as upper arm, fore arm, and hand. Offset bones are used to position the bone in its natural position. Parts are separated such that bone strengths can be adjusted to completely cover their image layers without affecting other image layers.

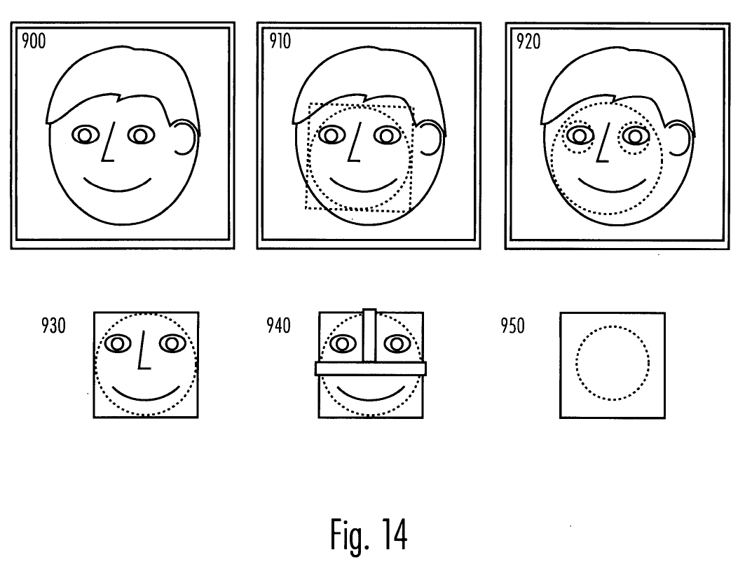

The following description, together with FIG. 14, describes one example of how a user-provided photo is prepared for incorporation into stock media, including a character skin-tone shading algorithm.

1. Start with a photo of a person's head (900). The subject's face should face primarily forward for best results, but the system is not limited by subject pose or orientation.

2. A user or automated algorithm marks four corners of a polygon that circumscribes the face (910). In one embodiment, the user places a marker on each eye establishing the facial orientation and positions and scales an oval inscribed in the four-sided polygon to define pixels belonging to the face (920). As the user makes adjustments, a preview image updates providing feedback to the user

3. The selected portion of the photo is resampled according to the equations 980 (see Exhibit A) such that the polygon in (910) is made square and the top edge is horizontal, producing a normalized face (930). Pixels near the edge are given transparency to allow blending the face image with the computed skin color forming a radial transparency gradient (950) such that pixels inside the circle are opaque and pixels outside the circle are more transparent further from the edge. The color of exterior pixels is a function of the pixel on the nearest edge

4. A subset of pixels horizontally across the middle of the normalized face and vertically from the top to the center is sampled (940). These pixels are chosen to avoid most pixels representing non-skin areas in the photo, like facial hair and eyes, and to include a range of lighting and skin color variations. Many functions may be used to combine the pixel values to compute an overall skin tone color. Equations 990 (see Exhibit B) show a possible embodiment of the color selection algorithm

5. The computed skin color is used as a background for customized stock media frames. The normalized face (930) is projected according to predetermined animation parameters to match with a template using the adjoint projection matrix computed in equations (980) and composited over the background based on a transparency mask. The compositing process is repeated for each face or photo in each animation frame. Finally, the system composites the stock media with transparency where the customizations should show through.

In general, customizing a character set up with a user-provided photo (portrait) includes the following steps. However, more sophisticated approaches can also used.

1. Import the user-provided photo with the new face

2. Crop the photo tight to the person's head

3. Link the face layer to the mask

4. Align and scale the face layer to match the masked region

5. Use the eye dropper to pick two colors from the skin tomes of the face

6. Select the head portion of the character art in the stock media

7. Apply a gradient fill from left to right on the head of the character

8. Pick a single color from the face with the eye dropper

9. Select and fill the rest of the skin tone areas of the character in the stock media, such as hands, neck, arms, and feet.

Integrate User-Provided Media with Stock Media (S307)

In step S307, the prepared user-provided and stock media are integrated into predefined spatial and temporal portions of the stock media utilizing a compositing algorithm to form a composited movie. Compositing occurs in the Processor Stack (28) and uses multiple alpha channels and various processors. Media creators may specify multiple alpha channels and masks to disambiguate masks intended for distinct user-supplied media. Different channels or masks are needed to prevent bleed through where multiple custom images are specified within the same video frame. A shared memory model could support multiple processors working on the same video frame using designated masking regions to prevent mediation.

Encode Movie and Deliver to User (S308)

First, the composited movie is compressed. Compression is achieved via software running on the Processor Stack (28) with multi-processor array optimized for minimum disk access. Scenes may be arranged such that the same stock media is maintained in memory while only the customer-provided media (which are relatively small by comparison) are successively composited. Preferably, completed scenes are immediately compressed from memory to save trips to secondary storage. Where possible, compressed video is passed directly to the authoring or publishing system.

Next, the compressed movie is authored into the format specified by the user in step S301. Menu and chapter creation software encodes the desired media format, country code, media specification, and file format. Based on the user's choice, the disc can be automatically played when inserted into the player, skipping the menus.

Next, information about orders status, advertising, and electronic delivery of completed movies or clips are emailed to the user or uploaded by FTP to user- or business-ally-defined website via the Server/Storage component (20) via the Internet (44). The Authoring Devices (34) then places the electronic data onto the physical media such as DVDs, CDs, VHS, or USB devices.

Next is the printing step. Physical media and accompanying box (e.g., jewel-case inserts or box) are optionally decorated with printing to default or user-defined settings including titles, pictures, and background colors. Paper-copies of orders, and order-specific mailing labels and invoices are also printed here.

Finally, the personalized movies are packaged and shipped. The Packaging, Shipping (40) is a combination of manual processes for taking completed media from the Printers (38) and Authoring Devices (34), packaging them, affixing mailing labels and postage, and then delivering the media for shipping to the end-user via U.S. or private mail carriers (42).

### Other Embodiments

The structures of the preferred embodiment described with reference to FIG. 1 are merely exemplary. The functionality of each structure described above may be consolidated into fewer structures or may be further sub-divided to make use of additional structures. For example, several of the primary components in the back end of the system (20, 24, 26, 28, 34) need not be distinct components but may be integrated into one structure or other multiple combinations.

For example, the functionality of each of the above structures could be combined in one stand-alone unit. In such an embodiment, the entire system (12-44), including the front-end of the system (12-18), is located in an enclosed kiosk-like structure. The kiosk may include user interface that receives user parameters and user-provided media. In addition, the kiosk may include a structure that takes a picture of the user with an internal camera. The kiosk would also include the hardware and software systems to perform face extraction on the images, create an articulated 2D animated character or other type of character that uses the user's face from extracted image, re-render or composite the stock media, compress and encode the video segments, and author the movie to a DVD which is delivered to the user. Thus, instead of a large distributed system, the kiosk embodiment is a smaller isolated embodiment placed in a stand-alone enclosure envisioned for use in retail stores or other public places. This embodiment may further include a built-in webcam to provide input images, smaller hardware, a cooling device, a local interface network, and image processing algorithms.

As another example, the system described with reference to FIG. 1 is a more or completely local system, collocating either or both of the front end (12), and web server (16), with the back-end system (20-44). Likewise, the system described with reference to FIG. 1 may be a more distributed system where most or all of the primary components (12, 16, 20, 24, 26, 28, 34, 38, 40) are not collocated and exists and operate at numerous different locations. For example, the functionality of the authoring device (34) and/or printers (36) may be at a third-party location. In such a case, electronic files (e.g., completed DVD disc images) are sent to the third-party/vendor where other authoring devices create the tangible media (DVD, CD, books, etc.). Shipping to the end user may then be handled by the third party. Similarly, authoring of tangible media may not be necessary at all, but rather electronic copies of the movie may be delivered to the user. Further in this regard, the invention is applicable in other business models such as business-to-consumer, mail-order, and retail, as well as business-to-business retail and wholesale.

The connectivity between the components shown is not limited to Internet and LAN connectivity as shown in FIG. 1. Inter-component connectivity (14, 18, 22, 30, 32, 36) may be an optical, parallel, or other fast connectivity system or network.

In addition to the flexibility of the arrangement of the structural components of the invention, the invention is also flexible with regard to the types of user-provided media that may integrated into stock media. The examples given above with regard to the preferred embodiments focused on the integration of a photograph (e.g., a user's face) into a character in the stock media. However, any type of media may be incorporated. As one example, the user-provided media may be an image of an object, such as a product, so that non-character aspects of the stock media may be personalized. For instance, stock media, such as feature-length motion pictures, could be personalized by inserting specific products (i.e., the user-provided object) into a scene. For example, different brands of cereal may be integrated into the feature-length movie for different regions of the U.S. or for different countries. As such, the invention provides a flexible solution for personalizing and adapting product placement in movies.

In addition, user-provided media such as text, images and sounds may also be integrated into stock media. As examples, audio files of a user's voice may be integrated into the stock media so that a personalized character may interact with stock character. Likewise, audio files that refer to the user may integrated so that a stock characters may refer to the personalized character by a specific desired name. User-provided text may also be integrated into stock media so that sub-titles or place names (e.g., a store sign) may be personalized.

Other Features and Variations:

(a) An algorithm that provides a list of available stock media for the user to choose after the user uploads the user-provided media. The stock media listed matches types and number of uploaded user-provided media.

(b) The Invention is not limited to personalization of movies, but may be adapted to add personalization to other media types such as sound (e.g., songs or speeches) and slide show type videos comprised solely of still images with or without audio.

(c) Rather than being uploaded electronically, the user-provided media may be mailed or delivered in the form of physical photographs, drawings, paintings, audio cassettes or compact discs, digital (still or movie) images on storage media, and/or that are manually, semi-automatically, or automatically digitized and stored on the Server/Storage (20).

(d) Processing on the Processor Stack (28) includes a range of compression, file types, and an Application Programming Interface (API) for adding third-party plug-ins to allow the ability to add new encoding formats to interact with or function in format-specific proprietary third-party software.

(e) Users upload and store their own stock media to the system Servers/Storage (20) or third party servers.

(f) Stock media, characters, or story scripts stored on end-user's personal computers or personal media storage that is exchanged and issued with client-server or centralized, decentralized, and/or anonymous peer-to-peer networks.

(g) Stock media storage and generation is based on scripted directions from the manufacturer or end-user. Specialized script syntax would contain high-level graphical and/or text descriptions of character and object states and behaviors, which users would use to create their own storylines and action sequences. The scripts would be interpreted by a Stock-Media sever and suite of processors and either composite component clips in the scripted order or produce new renderings.

(h) Image processing by the Processor Stack (28) includes scaling stock media frames to multiple final-format spatial (size) and temporal (frame rate) resolutions such as, but not limited to standard 4:3 such as NTSC (648×486), D1 NTSC (720×486), D1 NSC Square (720×540), Pal (720×486), D1 PAL (720×576), various 16:9 HD formats such as 720 p (1280×720) 1080 p (1920×1080), print quality resolutions for printed material, as well as reduced frame-rate (e.g., 5 or 10 fps) and spatial resolution for web and/or wireless-compatible, streaming, Flash, or other transmission standards or protocols.

(i) Packaging, Shipping (40) and the process of transferring and packing media is semi- or completely automated by conveyor-belt and/or robotic means.

(j) Output styles are stand-alone full-length motion pictures, videos, interactive games, or as individual clips in physical or electronic format to be used in consumer or professional linear or non-linear movie or media editors.

(k) Stock media of any type of video input may be used, including but not limited to 2D cartoon-style animation, digitized photographs, film or digital video, 3D computer graphics, photo-realistic rendered computer graphics and/or mixed animation styles rendered objects/characters/scenes and real video.

(l) Processor stack (28) is replaced by single processor or run locally on user's personal computer, or processor in their mobile/wireless devices.

(m) Storage devices for the Web Server (16), Server/Storage (20) Order Server (24), Resource Server (26), and Processor Stack (28) are not restricted to hard disks but could include optical, solid-state, and/or tape storage devices.

(n) Input devices (12) may be laptop computers, digital cameras, digital video camcorders, web cams, mobile phones, other camera-embedded devices, wireless devices, and/or handheld computers, and user-provided media could be sent via email, standard mail, wireless connections, and FTP and/or other Internet protocols.

(o) Output formats of media may be flash or other solid-state memory devices, hard or optical disks, broadcasted wirelessly, broadcasted on television, film, uploaded to phones or handheld computing devices, head-mounted displays, and/or live-streamed over the Internet (44) to Personal Computers (12) or presented on visual displays or projectors.

(p) Product selection is immersive and interactive including media-pull approaches, spoken dialog, selections based on inference, artificial intelligence, and/or probabilistic selections based on previous user habits or other user information from third-party sources.

(q) Media integrates educational and life-lessons, cultural and behavioral teaching, how-tos, instructional videos, personalized psychological treatment or coping mechanisms for stress, loss, or new situations.

(r) Compositing, compression, encoding, and media authoring performed by specialized hardware.

(s) Hard-disk or memory buffers used in the processor stack keep bit rate constant to meet demands of certain authoring (e.g., DVDR, CDR, VHS, computer files) devices.

(t) Cropping of faces from normal photographs in initial image processing performed by the web server (16) and is automated using existing face recognition algorithms that use specific facial features (such as eyes, nose, cheek bones, ears) or other image-processing techniques involving contrast variation, edge detection, smoothing, clustering, principal component, or wavelet analysis methods to isolate faces in complex scenes.

(u) Initial image processing algorithms and face and/or voice isolation algorithms run as a client-side application on the user's (10) personal computer (12) and/or as part of the back-end system's processors (28).

(v) Software-only embodiment that uses the end-user's own computer to do most or all of the image processing, compositing, encoding, rendering, compression, and/or authoring as well as the creation and/or storage of new and/or stock media.

(w) Redundant and/or backup components and tape, DVDR, or other media forms of backup are integrated into the system to handle power loss, software or hardware failures, viruses, or human error.

(x) More advanced user profiles are used for a wider range of interaction and user control.

(y) Novel user-defined and uploaded stock characters or objects are rendered into base media. For example the user could create and replace a complete character in a scene and the system will regenerate the necessary rendering.

(z) The Order Server (24) integrates a symbol-tracking system for monitoring individual media from Authoring Device (34) to Printers (38) to Packaging, Shipping (40). Symbols printed on media, packing slips, and mailing labels can be checked to make sure the media coming from the authoring and printing devices are packed and shipped to the right address. For example, bar codes are produced for each physical element of an order: disc, box, shipping label, and jewel case cover to assist a human or machine to match items belonging to the same order. The scanning system allows successive scanning of multiple bar codes to help ensure proper grouping of items.

(aa) Automated postage can be purchased over the Internet and integrated into the Order Server (24) for enhanced shipping and package tracking.

(bb) A system in which the functionality Order Server (24) and/or Printers (38) are not included.

(cc) An automated box printer and folder are added to the collection of Printers (38) to enhance the aesthetics of the packaging.

(dd) Automated image-processing techniques such as Fourier or wavelet analyses are used for quality control on finished media or for intermediate electronic versions in the Processor Stack (28) in order to check for dropped frames, faulty compression or encoding, and other quality control issues. Thresholded spectral analyses, auto- or reverse correlation, clustering, and/or spatio-temporal delta mapping techniques of spurious artifacts from a know or desired pattern measured from random or pre-selected frames or series of frames can automatically detect low quality products that can be re-made using different compression/encoding parameters.

(ee) A user (10) performs a manual source image (i.e., the user-provided media) registration process that involves the user (10) using a computer mouse to click on particular image features to create registration marks or lines used by downstream image processing (16, 28) to align, register, crop, and warp images of face, body, and object to a normalized space or template which can then be warped or cropped to meet the specifications or requirements of future image processing or compositing to stock media. For example, a user would create a simple line skeleton (over an uploaded picture in a web browser), where successive pairs of clicks identified the major body axis (from head to pelvis) and axes of joints (from shoulder to elbow and elbow to hand, etc.). A similar process can identify the orientation of the face with identifications of each eye establishing a horizontal line to calculate in-plane rotation, and a vertical line from mid forehead to nose and/or chin, to calculate rotations in depth. These registration lines can be automatically calculated by software and used to warp a non-straight-on picture of people, animals, or objects' faces or bodies to a standard alignment, and then warped to other orientations.

(ff) Automated or subsystems in the Processor Stack (28) or Authoring Devices (34) adjust parameters for bit-rate thresholds to prevent dropped frames during authoring.

(jj) Thermal and/or ink-jet label printing for physical media is integrated into the same hardware for authoring DVD or CD media.

(kk) Resource Server (26) and/or Order Server (24) are connected to the Authoring Devices (34) and/or Printers (38) via local area networks or other devices for monitoring printing and authoring status/progress.

(ll) The Order Server (24) is connected to the Processor Stack (28) via a Local Area Network or similar high-speed connection.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

1. A production method for creating personalized movies comprising steps of:
receiving user-provided media;
receiving parameters which define how a user wants the movies to be personalized; and
optimizing production tasks along relevant dimensions utilizing an optimization algorithm in accordance with the received parameters.

2. The production method of claim 1, wherein the optimization algorithm utilizes load balancing techniques to maximize order throughput, the load balancing technique including the steps of:
analyzing scheduled activity, including disk activity, for potential performance penalties; minimizing disk activity that imposes performance penalties identified in the analyzing step and maximizing in-memory computation.

3. The production method of claim 1, wherein the production tasks are performed by two or more CPUs and the optimization algorithm divides the production among available CPUs along orthogonal dimensions.

4. The production method of claim 3, wherein the orthogonal directions include orders, stories, scenes, frames, user, and user media.

5. The production method of claim 1, wherein the optimization algorithm includes the step of performing dynamic statistical analysis on historical orders and current load used for strategic allocation of resources.

6. A production system for creating personalized movies comprising:
a receiving unit for receiving user-provided media and parameters which define how a user wants the movies to be personalized; and
an optimizing unit for optimizing production tasks along relevant dimensions utilizing an optimization algorithm in accordance with the received parameters.

7. The production system of claim 6, wherein the optimization algorithm performs load balancing techniques to maximize order throughput, the load balancing technique including the steps of:
analyzing scheduled activity, including disk activity, for potential performance penalties; minimizing disk activity that imposes performance penalties identified in the analyzing step and maximizing in-memory computation.

8. The production system of claim 6, wherein the production tasks are performed by two or more CPUs and the optimization algorithm divides the production among available CPUs along orthogonal dimensions.

9. The production system of claim 8, wherein the orthogonal directions include orders, stories, scenes, frames, user, and user media.

10. The production system of claim 6, wherein the optimization algorithm includes the step of performing dynamic statistical analysis on historical orders and current load used for strategic allocation of resources.

11. A production system for creating a personalized movie comprising personalized-stock-media wherein the production system comprises:
a receiving unit which receive a user-media and a user-parameter from a user;
a preparing unit which prepares the user-media to generate a prepared-user-media;
a storage unit which has stored therein a plurality of stock media each stock media having associated therewith a stock media template;
an integrating unit which,
receives the prepared-user-media and a user-parameter,
receives a selected stock media and a selected stock media template selected in response to a user-parameter,
integrates the prepared-user media into spatial and temporal portions of the selected stock media defined by the stock-media template to generate said personalized-stock-media;
an optimizing unit for optimizing production tasks along relevant dimensions utilizing an optimization algorithm in accordance with the received parameters.
